(19) United States
(12) Patent Application Publication
(10) Pub. No.: US 2009/0207203 A1
(43) Pub. Date: Aug. 20, 2009

(54) INK JET RECORDING APPARATUS AND INK JET RECORDING METHOD

(75) Inventor: Keizaburo Yamamoto, Shizuoka-ken (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/370,150

(22) Filed: Feb. 12, 2009

(30) Foreign Application Priority Data
Feb. 19, 2008 (JP) 2008-037840

(51) Int. Cl. B41J 29/38; B41J 2/01

(52) U.S. Cl. 347/16; 347/102

(57) ABSTRACT

The ink jet recording apparatus includes an ink jet head configured to discharge UV ink onto a printed article fed in a feeding direction, an ultraviolet irradiation device having a single light source capable of irradiating light including a first wave length zone to reform a surface of the printed article and a second wave length zone for hardening the UV ink, and a controller configured to control the light source so as to emit light in the first wave length zone and light in the second wave length zone.

### CROSS-REFERENCE TO RELATED APPLICATION

This application is based upon and claims the benefit of priority from the prior Japanese Patent Application No. 2008-037840, filed on Feb. 19, 2008; the entire contents of all of which are incorporated herein by reference.

### FIELD OF THE INVENTION

The present invention relates to an ink jet recording apparatus using UV ink.

### DESCRIPTION OF THE BACKGROUND

In Japanese Patent Application Publication No. 2003-311940, an ink jet recording apparatus is disclosed. The ink jet recording apparatus includes a surface reforming portion for adjusting the wettability of a printed article, an ink jet head for discharging UV ink onto the printed article with the wettability with ink improved, and an ultraviolet irradiation portion for hardening the ink discharged onto the printed article. The surface reforming portion is composed of a plasma surface reforming device and a corona discharger. The surface reforming portion, ink jet head, and ultraviolet irradiation portion are arranged in a row.

In the ink jet recording apparatus, each printed article is conveyed with the surface thereof reformed at the surface reforming portion. To this printed article, UV ink is discharged by the ink jet head. Further, at the ultraviolet irradiation portion, ultraviolet light is irradiated to the printed article and the ink is fixed onto the printed article.

However, in the ink jet recording apparatus aforementioned, as a surface reforming portion, the plasma surface reforming device and corona discharger are used, so that not only the apparatus is enlarged but also the entire apparatus is expensive. Further, the surface reforming portion, ink jet head, and ultraviolet irradiation portion are arranged in a row, so that the apparatus can process printed articles only in one direction. Therefore, the production efficiency is low.

### SUMMARY OF THE INVENTION

An object of the present invention is to provide an ink jet recording apparatus having a simple and inexpensive constitution for efficiently performing the print process.

The ink jet recording apparatus relating to an embodiment of the present invention comprise an ink jet head configured to discharge UV ink onto a printed article fed in a feeding direction; an ultraviolet irradiation device having a single light source capable of irradiating light including a first wave length zone to reform a surface of the printed article and a second wave length zone for hardening the UV ink; and a controller configured to control the light source so as to emit light in the first wave length zone and light in the second wave length zone.

Furthermore, the ink jet recording method relating to an embodiment of the present invention comprises irradiating light in a first wave length zone from an ultraviolet irradiation device so as to improve wettability of a surface of a printed article fed in a feeding direction; discharging UV ink to the printed article fed in the feeding direction and improved in the wettability; and irradiating light in a second wave length zone from the ultraviolet irradiation device so as to harden the UV ink adhered to the printed article.

### BRIEF DESCRIPTION OF THE DRAWINGS

FIG. 1 is a perspective view showing the entire constitution of the ink jet recording apparatus relating to the first embodiment;

FIG. 2 is a plan view showing the structure of the periphery of the carriage of the ink jet recording apparatus shown in FIG. 1;

FIG. 3 is a front view showing the peripheral structure of the carriage shown in FIG. 2 in the front direction;

FIG. 4 is a graph showing the light emission spectrum of the mercury lamp which is the light source of the ultraviolet irradiation device of the ink jet recording apparatus shown in FIG. 1;

FIG. 5 is a graph showing the light emission spectrum of the mercury lamp which is the light source of the ultraviolet irradiation device of the ink jet recording apparatus shown in FIG. 1;

FIG. 6 is a block diagram including the controller for controlling to drive the carriage and ultraviolet irradiation device of the ink jet recording apparatus shown in FIG. 1;

FIG. 7 is a top view showing the peripheral structure of the ink jet head of the ink jet recording apparatus relating to the second embodiment;

FIG. 8 is a top view showing the peripheral structure of the carriage of the ink jet recording apparatus relating to the third embodiment;

FIG. 9 is a top view showing the peripheral structure of the carriage of the ink jet recording apparatus relating to the fourth embodiment;

FIG. 10 is a top view showing the peripheral structure of the carriage of the ink jet recording apparatus relating to the fifth embodiment;

FIG. 11 is a bottom view showing the peripheral structure of the carriage of the ink jet recording apparatus relating to the sixth embodiment from underneath;

FIG. 12 is a bottom view showing the peripheral structure of the carriage of the ink jet recording apparatus relating to the seventh embodiment from underneath;

FIG. 13 is a bottom view showing the peripheral structure of the carriage of the ink jet recording apparatus relating to the eighth embodiment from underneath;

FIG. 14 is a front view showing the status of the carriage moving leftward from front in the ink jet recording apparatus relating to the ninth embodiment;

FIG. 15 is a front view showing the status of the carriage moving rightward from front in the ink jet recording apparatus shown in FIG. 14;

FIG. 16 is a front view showing the status of the carriage moving leftward from front in the ink jet recording apparatus relating to the tenth embodiment; and

FIG. 17 is a front view showing the status of the carriage moving rightward from front in the ink jet recording apparatus relating to the tenth embodiment.

### DETAILED DESCRIPTION OF THE INVENTION

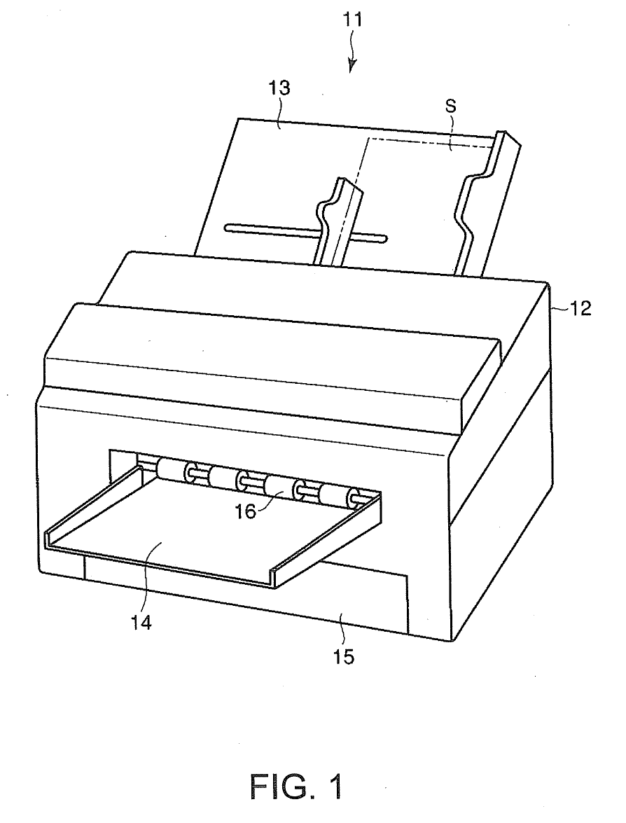

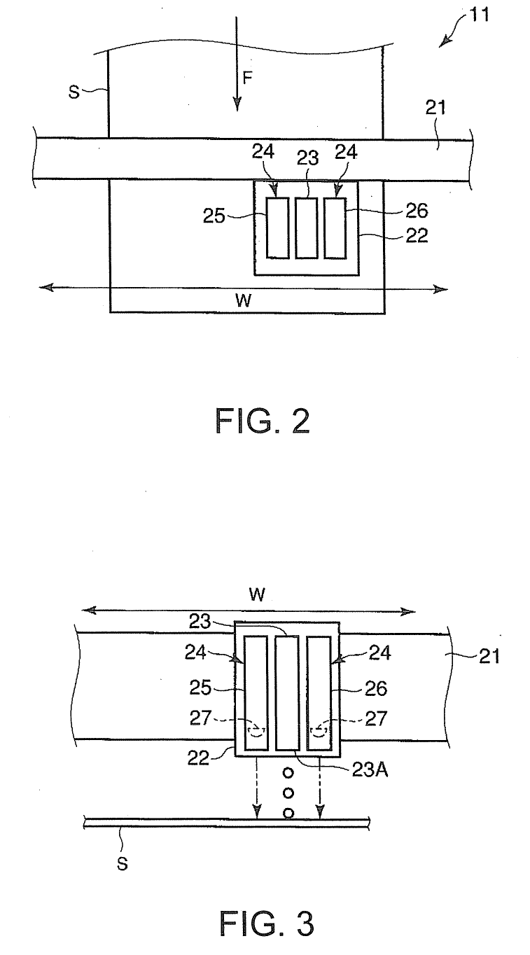

Hereinafter, the embodiments of the present invention will be explained with reference to the accompanying drawings. In FIG. 1, the entire constitution of the ink jet recording apparatus is shown.

An ink jet recording apparatus 11 includes a main body 12 and on the rear of the main body 12, a first sheet supply tray 13 is installed and on the front thereof, a receiving tray 14 is installed. At the lower part of the main body 12, a second sheet supply tray 15 is installed. Further, the apparatus 11 has rollers 16 for feeding a sheet S which is an example of a printed article in a feeding direction F. The sheet S is an example of recording media. Further, the printed article is not limited to the sheet S and it may be a medium having good wettability such as a plastic sheet, a metallic sheet, or a film. As a completed article formed by printing a printed article, a body advertisement of a streetcar or a bus, a street advertisement, a CD or DVD package, a portable telephone frame, a package of food and drink, and a card such as a staff certificate may be cited.

The ink jet recording apparatus 11 includes a carriage guide shaft 21 stored in the main body 12, a carriage 22 moving back and forth along the carriage guide shaft 21, and an ink jet head 23 and an ultraviolet irradiation device (hereinafter, referred to as a UV irradiation device) 24 which are loaded in the carriage 22. The carriage 22 moves back and forth in a width direction W of the sheet S. Further, at the position opposite to the carriage 22, the sheet S conveyed by the rollers 16 is arranged. The ink jet head 23 includes, for example, a nozzle 23A and a piezo-electric element made of PZT (titanium zirconate) which is a driving element. By driving by the piezo-electric element, as shown in FIG. 3, from the nozzle 23A, ultraviolet hardening ink (hereinafter, referred to as UV ink) is discharged toward the sheet S.

The UV irradiation device 24 hardens the UV ink adhered to the sheet S and fixes it to the sheet S. The UV irradiation device 24 is composed of a pair of UV irradiation devices including a first unit 25 and a second unit 26 which are loaded on the carriage 22. At a position between the first unit 25 and the second unit 26, the ink jet head 23 is arranged. The ink jet head 23 and the first unit 25 and second unit 26 of the UV irradiation device 24 are arranged in line with each other on the carriage 22 in the width direction W. The first unit 25 and second unit 26 of the UV irradiation device 24, as shown by a two-dot chain line in FIG. 3, irradiate UV light to the sheet S.

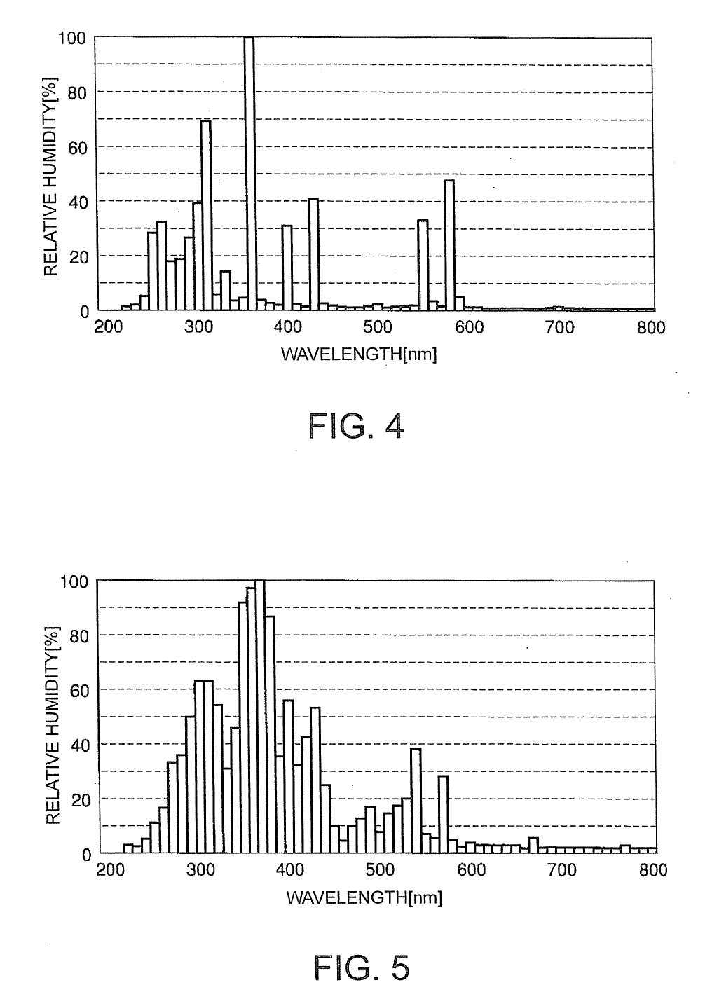

The UV irradiation device 24 serves as a surface reforming portion to reform the surface of a printed article prior to discharge of UV ink and improving the wettability of the printed article to the UV ink. Namely, the first unit 25 and second unit 26 of the UV irradiation device 24 have a light source 27 for irradiating UV light, that is, a UV lamp. As an example of the UV lamp as the light source 27, there is a mercury lamp or a metal halide lamp. The light emission spectrum of the mercury lamp is shown in FIG. 4. Further, the light emission spectrum of the metal halide lamp is shown in FIG. 5. In the ink jet recording apparatus 11 of this embodiment, either of the mercury lamp and metal halide lamp may be used.

The mercury lamp and metal halide lamp which are the light source 27 respectively include a first wave length zone to reform the surface of the sheet S which is a printed article and a second wave length zone for hardening UV ink. The first wave length zone is, for example, UV-A (400 to 315 nm). The second wave length zone is, for example, UV-C (280 to 10 nm).

The aforementioned is the first embodiment of the ink jet recording apparatus 11. According to the first embodiment, the ink jet recording apparatus 11 includes the ink jet head 23 for discharging UV ink to a printed article fed in the feeding direction F and the UV irradiation device 24 for hardening the UV ink adhered to the printed article and the UV irradiation device 24 for hardening the UV ink adhered to the printed article and the UV irradiation device 24 serves as a surface reforming portion to reform the surface of the printed article prior to discharge of the UV ink and improving the wettability of the printed article to the UV ink.

According to this constitution, the UV irradiation device 24 can be provided with the function of the surface reforming portion, so that compared with the case that a surface reforming portion is installed separately, the constitution of the ink jet recording apparatus 11 can be simplified. Further, the manufacturing cost of the ink jet recording apparatus 11 can be reduced.

In this case, the UV irradiation device 24 has the light source 27 capable of irradiating light including the first wave length zone to reform the surface of the printed article and the second wave length zone for hardening the UV ink. According to this constitution, the UV irradiation device 24 can be provided with the function to reform the surface of the printed article and the function for hardening the UV ink. Further, both functions can be realized by the common light source 27, so that the constitution of the ink jet recording apparatus 11 can be simplified.

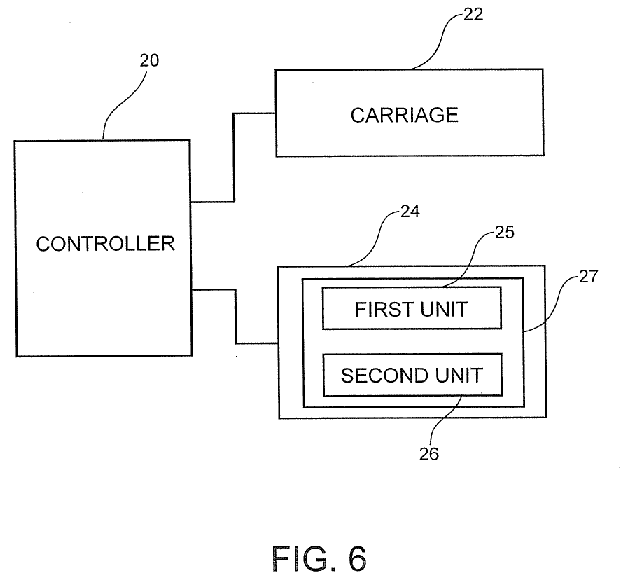

FIG. 6 shows the block diagram including the controller 20 for controlling to drive the carriage 22 and UV irradiation device 24 of the ink jet recording apparatus 11.

The controller 20 is connected to the carriage 22 and UV irradiation device 24. The carriage 22 moves back and forth under the control of the controller 20. The light source 27 incorporated in the UV irradiation device 24 is controlled alternately in the time of emission of light in the first wave length zone and the time of emission of light in the second wave length zone under the control of the controller 20. Namely, when the carriage 22 moves forth, the first unit 25, in order to reform the surface of the printed article, controls the light source 27 so that light in the first wave length zone is emitted by the controller. So as to harden the UV ink after printing, the second unit 26 controls the light source 27 so that light in the second wave length zone is emitted by the controller.

When the carriage 22 moves back, to permit the second unit 26 to reform the surface of the printed article, the controller 20 controls the light source 27 so as to emit light in the first wave length zone from the light source 27. And, to permit the first unit 25 to harden the UV ink after printing, the controller 20 controls the light source 27 so as to emit light in the second wave length zone from the light source 27.

In this case, the UV irradiation device 24 is composed of a pair of UV irradiation devices including the first unit 25 and second unit 26 and the ink jet head 23 is arranged at a position between the first unit 25 and the second unit 26. According to this constitution, prior to printing by the ink jet head 23, the surface of the printed article is reformed and after printing, the UV ink can be hardened.

In this case, the apparatus has the carriage 22 which loads the ink jet head 23 and UV irradiation device 24 and can move back and forth in the width direction W and the ink jet head 23 and the first unit 25 and second unit 26 of the UV irradiation device 24 are arranged in line with each other on the carriage 22 in the width direction W. According to this constitution, the first unit 25 and second unit 26 are arranged across the ink jet head 23. Therefore, even when the carriage 22 moves in either direction, the surface is reformed prior to printing and after printing, the UV ink can be hardened.

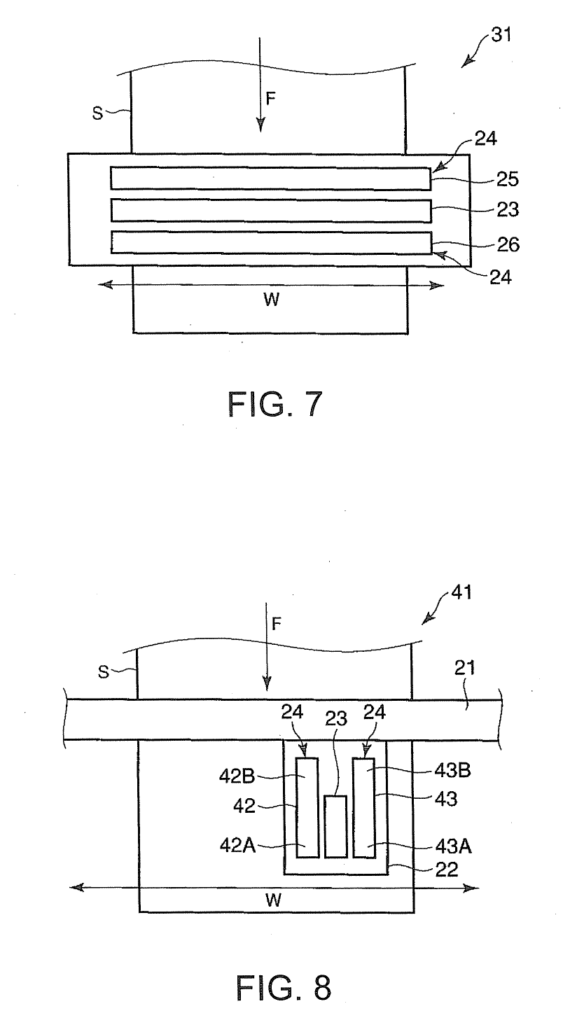

Then, by referring to FIG. 7, the second embodiment of an ink jet recording apparatus 31 will be explained. The ink jet recording apparatus 31 of the second embodiment has a different constitution of the ink jet head 23 and the first unit 25 and second unit 26 of the UV irradiation device 24 from that of the first embodiment, though the other portions are common. Therefore, the portions different from those of the first embodiment will be explained mainly and to the portions common to the first embodiment, the common numerals are assigned and the explanation thereof will be omitted.

The ink jet recording apparatus 31 relating to the second embodiment is the so called line type apparatus. The ink jet recording apparatus 31 has the ink jet head 23 and UV irradiation device 24. The UV irradiation device 24 includes the first unit 25 and second unit 26. The ink jet head 23 and the first unit 25 and second unit 26 of the UV irradiation device 24, in the width direction W orthogonal to the feeding direction F of the sheet S, are formed longer than the width of the sheet S. The ink jet head 23 and UV irradiation device 24 are arranged so as to extend over the full width of the sheet S. The ink jet head 23 and the first unit 25 and second unit 26 of the UV irradiation device 24 are arranged in line with each other in the feeding direction F of the sheet S. In the second embodiment, the sheet S is fed also in the opposite direction to the feeding direction F of the sheet S. Namely, the sheet S is printed by moving it back and forth in the direction of the arrow F. In this case, the second unit 26 reforms the surface of the sheet S and the first unit 25 hardens the UV ink.

According to the second embodiment, even if the ink jet head 23 has a line type constitution, the surface reforming before printing and hardening of UV ink after printing can be realized by the UV irradiation device 24.

Then, by referring to FIG. 8, the third embodiment of an ink jet recording apparatus 41 will be explained. The ink jet recording apparatus 41 of the third embodiment has a different constitution of a first unit 42 and a second unit 43 of the UV irradiation device 24 from that of the first embodiment, though the other portions are common. Therefore, the portions different from those of the first embodiment will be explained mainly and to the portions common to the first embodiment, the common numerals are assigned and the explanation thereof will be omitted.

The UV irradiation device 24 of the ink jet recording apparatus 41 relating to the third embodiment includes the first unit 42 and second unit 43. The first unit 42 and second unit 43, in the feeding direction F of the sheet S, is formed longer than the length of the ink jet head 23.

The first unit 42 and second unit 43 of the UV irradiation device 24 respectively include corresponding portions 42A and 43A corresponding to the ink jet head 23 in the feeding direction F and projecting portions 42B and 43B off the ink jet head 23 in the feeding direction F. The projecting portions 42B and 43B are arranged on the upstream side of the ink jet head 23 in the feeding direction F.

According to the third embodiment, prior to printing by the ink jet head 23, a lot of time can be put in the surface reforming of the sheet S. Therefore, when printing on the sheet S taking a lot of time in the surface reforming or on a metallic sheet, a plastic sheet, or a film which are a printed article taking a lot of time in the surface reforming, UV light is irradiated for a long period of time, thus the wettability of the UV ink to the sheet S can be improved.

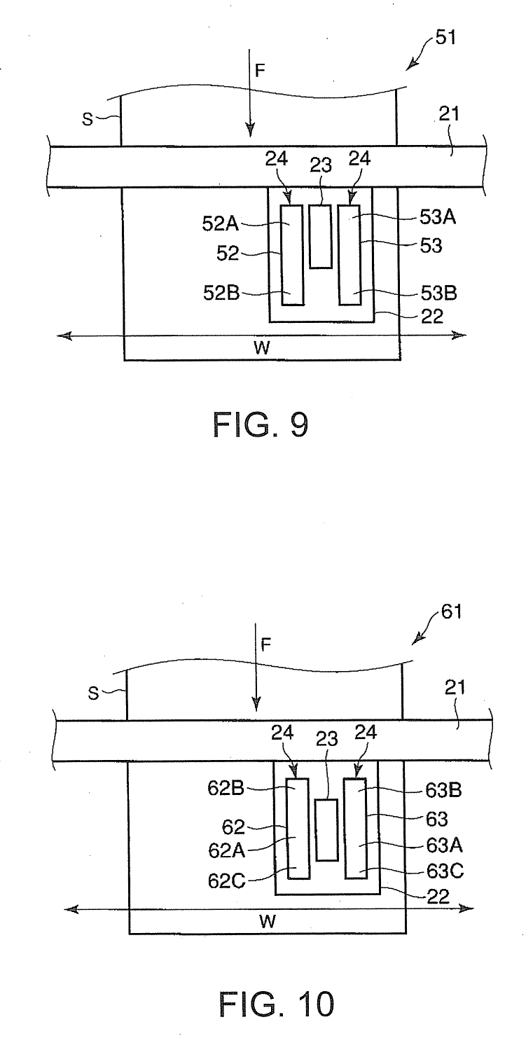

By referring to FIG. 9, the fourth embodiment of an ink jet recording apparatus 51 will be explained. The ink jet recording apparatus 51 of the fourth embodiment has a different constitution of a first unit 52 and a second unit 53 of the UV irradiation device 24 from that of the first embodiment, though the other portions are common. Therefore, the portions different from those of the first embodiment will be explained mainly and to the portions common to the first embodiment, the common numerals are assigned and the explanation thereof will be omitted.

The UV irradiation device 24 of the ink jet recording apparatus 51 relating to the fourth embodiment includes the first unit 52 and second unit 53. The first unit 52 and second unit 53, in the feeding direction F of the sheet S, is formed longer than the length of the ink jet head 23.

The first unit 52 and second unit 53 of the UV irradiation device 24 respectively include corresponding portions 52A and 53A corresponding to the ink jet head 23 in the feeding direction F and projecting portions 52B and 53B off the ink jet head 23 in the feeding direction F. In the fourth embodiment, unlike the third embodiment, the projecting portions 52B and 53B are arranged on the downstream side of the ink jet head 23 in the feeding direction F.

According to the fourth embodiment, after ending of printing by the ink jet head 23, a lot of time can be put in hardening of the UV ink. Therefore, even when using UV ink taking a lot of time in hardening, the UV ink can be fixed sufficiently to the sheet S.

By referring to FIG. 10, the fifth embodiment of an ink jet recording apparatus 61 will be explained. The ink jet recording apparatus 61 of the fifth embodiment has a different constitution of a first unit 62 and a second unit 53 of the UV irradiation device 24 from that of the first embodiment, though the other portions are common. Therefore, the portions different from those of the first embodiment will be explained mainly and to the portions common to the first embodiment, the common numerals are assigned and the explanation thereof will be omitted.

The UV irradiation device 24 of the ink jet recording apparatus 61 relating to the fifth embodiment includes the first unit 62 and second unit 63. The first unit 62 and second unit 63, in the feeding direction F of the sheet S, is formed longer than the length of the ink jet head 23.

The first unit 62 and second unit 63 of the UV irradiation device 24 respectively include corresponding portions 62A and 63A corresponding to the ink jet head 23 in the feeding direction F and first projecting portions 62B and 63B and second projecting portions 62C and 63C which are off the ink jet head 23 in the feeding direction F. The first projecting portions 62B and 63B are arranged on the upstream side of the ink jet head 23 in the feeding direction F and the second projecting portions 62C and 63C are arranged on the downstream side of the ink jet head 23 in the feeding direction F.

According to the fifth embodiment, compared with the first embodiment, a lot of time can be put in both surface reforming prior to printing and hardening of UV ink after printing. Therefore, even when the surface reforming of the sheet S takes a lot of time and hardening of UV ink takes a lot of time, the UV ink can be fixed sufficiently.

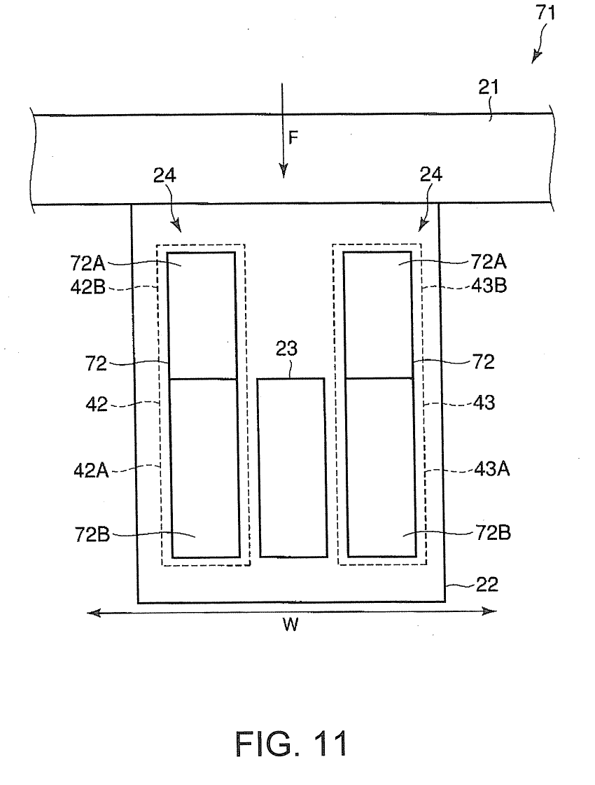

By referring to FIG. 11, the sixth embodiment of an ink jet recording apparatus 71 will be explained. The ink jet recording apparatus 71 of the sixth embodiment is different in the respect that it has a filter member 72 from the third embodiment shown in FIG. 8, though the other portions are common. Therefore, the portions different from those of the third embodiment will be explained mainly and to the portions common to the third embodiment, the common numerals are assigned and the explanation thereof will be omitted.

FIG. 11 shows the carriage 22 of the ink jet recording apparatus 71 relating to the sixth embodiment from underneath. The ink jet recording apparatus 71 relating to the sixth embodiment further has the filter member 72 attached to the carriage 22. The filter member 72 includes a first filter portion 72A and a second filter portion 72B. The first filter portion 72A is installed in correspondence to the respective projecting portions 42B and 43B of the first unit 42 and second unit 43 of the UV irradiation device 24. The first filter portion 72A, among light irradiated from the UV irradiation device 24, interrupts the light in the second wave length zone, though transmits the light in the first wave length zone.

The second filter portion 72B is installed in correspondence to the respective corresponding portions 42A and 43A of the first unit 42 and second unit 43 of the UV irradiation device 24. The second filter portion 72B, among light irradiated from the UV irradiation device 24, interrupts the light in the first wave length zone, though transmits the light in the second wave length zone.

According to the sixth embodiment, the ink jet recording apparatus 71 further includes the filter member 72 having the first filter portion 72A installed in correspondence to the projecting portions 42B and 43B for transmitting, among light irradiated from the first unit 42 and second unit 43 of the UV irradiation device 24, the light in the first wave length zone and interrupting the light in the second wave length zone and the second filter portion 72B installed in correspondence to the corresponding portions 42A and 43A for transmitting, among the light irradiated from the first unit 42 and second unit 43 of the UV irradiation device 24, the light in the second wave length zone and interrupting the light in the first wave length zone.

According to this constitution, in the projecting portions 42B and 43B, only the first wave length zone necessary for the surface reforming prior to printing can be taken out from UV light. By doing this, light in the wave length zone not used for surface reforming is irradiated, thus the surface of the sheet S can be prevented from bad influences. Further, in the corresponding portions 42A and 43A, only the second wave length zone necessary for hardening of UV ink can be taken out from UV light and by irradiation of the UV light, the UV ink can be prevented from unintended bad influences.

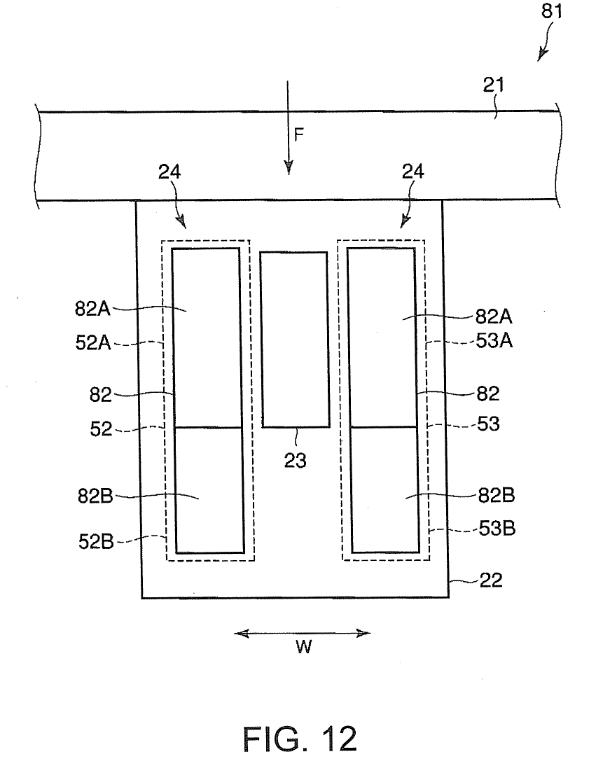

By referring to FIG. 12, the seventh embodiment of an ink jet recording apparatus 81 will be explained. The ink jet recording apparatus 81 of the seventh embodiment is different in the respect that it has a filter member 82 from the fourth embodiment shown in FIG. 9, though the other portions are common. Therefore, the portions different from those of the fourth embodiment will be explained mainly and to the portions common to the fourth embodiment, the common numerals are assigned and the explanation thereof will be omitted.

FIG. 12 shows the carriage 22 of the ink jet recording apparatus 81 relating to the seventh embodiment from underneath. The ink jet recording apparatus 81 relating to the seventh embodiment further has the filter member 82 attached to the carriage 22. The filter member 82 includes a first filter portion 82A and a second filter portion 82B of the UV irradiation device 24. The first filter portion 82A is installed in correspondence to the respective projecting portions 52A and 53A of the first unit 52 and second unit 53 of the UV irradiation device 24. The first filter portion 82A, among light irradiated from the UV irradiation device 24, interrupts the light in the second wave length zone, though transmits the light in the first wave length zone.

The second filter portion 82B is installed in correspondence to the respective projecting portions 52B and 53B of the first unit 52 and second unit 53 of the UV irradiation device 24. The second filter portion 82B, among light irradiated from the UV irradiation device 24, interrupts the light in the first wave length zone, though transmits the light in the second wave length zone.

According to the seventh embodiment, the ink jet recording apparatus 81 further includes the filter member 82 having the first filter portion 82A installed in correspondence to the corresponding portions 52A and 53A for transmitting, among light irradiated from the first unit 52 and second unit 53 of the UV irradiation device 24, the light in the first wave length zone and interrupting the light in the second wave length zone and the second filter portion 82B installed in correspondence to the projecting portions 52B and 53B for transmitting, among the light irradiated from the first unit 52 and second unit 53 of the UV irradiation device 24, the light in the second wave length zone and interrupting the light in the first wave length zone.

According to this constitution, in the corresponding portions 52A and 53A, only the first wave length zone necessary for the surface reforming prior to printing can be taken out from UV light, and light in the wave length zone not used for surface reforming is irradiated, thus the surface of the sheet S can be prevented from bad influences. Further, in the corresponding portions 52A and 53A, only the second wave length zone necessary for hardening of UV ink can be taken out from UV light and by irradiation of the UV light, the UV ink can be prevented from unintended bad influences.

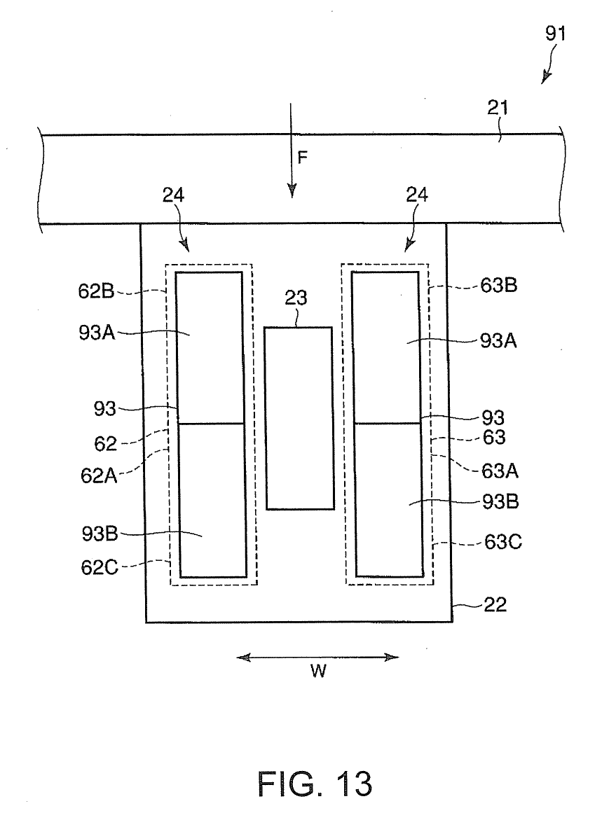

By referring to FIG. 13, the eighth embodiment of an ink jet recording apparatus 91 will be explained. The ink jet recording apparatus 91 of the eighth embodiment is different in the respect that it has a filter member 93 from the fifth embodiment, though the other portions are common. Therefore, the portions different from those of the fifth embodiment will be explained mainly and to the portions common to the fifth embodiment, the common numerals are assigned and the explanation thereof will be omitted.

FIG. 13 shows the carriage 22 of the ink jet recording apparatus 91 relating to the eighth embodiment from underneath. The ink jet recording apparatus 91 relating to the eighth embodiment further has the filter member 93 attached to the carriage 22. The filter member 93 includes a first filter portion 93A and a second filter portion 93B. The first filter portion 93A is installed in correspondence to the respective first projecting portions 62B and 63B of the first unit 62 and second unit 63 and a part of the corresponding portions 62A and 63A. The first filter portion 93A, among light irradiated from the UV irradiation device 24, interrupts the light in the second wave length zone, though transmits the light in the first wave length zone.

The second filter portion 93B is installed in correspondence to a part of the respective second projecting portions 62C and 63C and corresponding portions 62A and 63A of the first unit 62 and second unit 63. The second filter portion 93B, among light irradiated from the UV irradiation device 24, interrupts the light in the first wave length zone, though transmits the light in the second wave length zone.

According to the eighth embodiment, the ink jet recording apparatus 91 further includes the filter member 93 having the first filter portion 93A installed in correspondence to a part of the first projecting portions 62B and 63B and the corresponding portions 62A and 63A for transmitting, among light irradiated from the first unit 62 and second unit 63 of the UV irradiation device 24, the light in the first wave length zone and interrupting the light in the second wave length zone and the second filter portion 93B installed in correspondence to a part of the second projecting portions 62C and 63C and the corresponding portions 62A and 63A for transmitting, among the light irradiated from the first unit 62 and second unit 63 of the UV irradiation device 24, the light in the second wave length zone and interrupting the light in the first wave length zone.

According to this constitution, in a part of the first projecting portions 62B and 63B and the corresponding portions 62A and 63A, only the first wave length zone necessary for the surface reforming can be taken out from UV light, and light in the wave length zone not used for surface reforming is irradiated, thus the surface of the sheet S can be prevented from bad influences. Further, in the second projecting portions 62C and 63C and a part of the corresponding portions 62A and 63A, only the second wave length zone necessary for hardening of UV ink can be taken out from UV light and by irradiation of the UV light, the UV ink can be prevented from unintended bad influences.

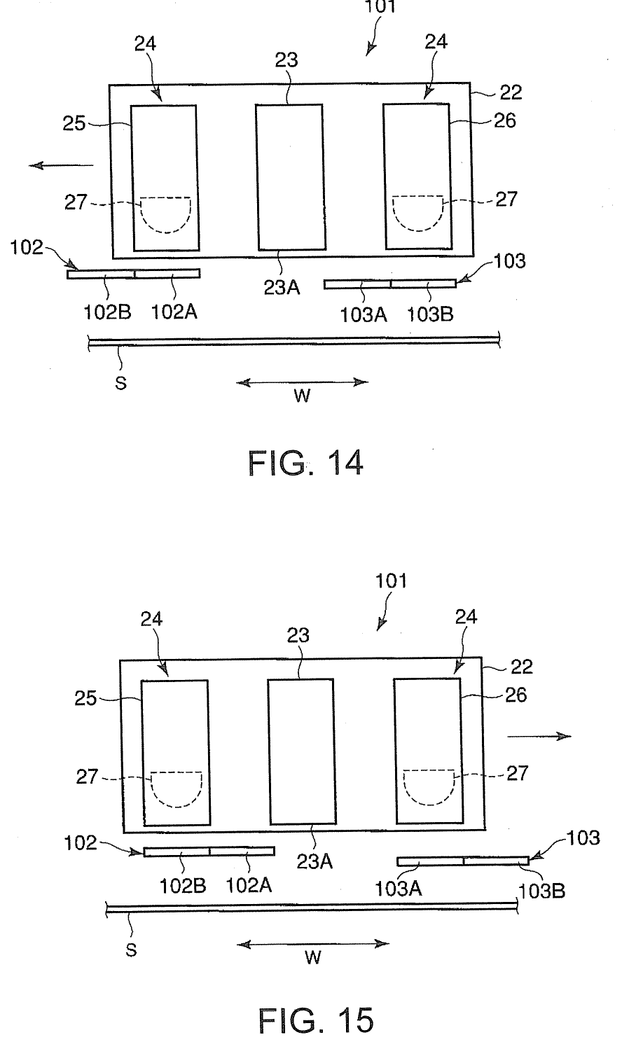

By referring to FIGS. 14 and 15, the ninth embodiment of an ink jet recording apparatus 101 will be explained. The ink jet recording apparatus 101 of the ninth embodiment is different in the respect that it has movable first and second filter members 102 and 103 from the first embodiment, though the other portions are common. Therefore, the portions different from those of the first embodiment will be explained mainly and to the portions common to the first embodiment, the common numerals are assigned and the explanation thereof will be omitted.

The first and second members 102 and 103 are attached respectively to the carriage 22 so that they can move by sliding.

The first filter member 102 is installed in correspondence to the first unit 25. The first filter member 102 has a first filter portion 102A and a second filter portion 102B. The first filter portion 102A, among light irradiated from the UV irradiation device 24, interrupts the light in the second wave length zone, though transmits the light in the first wave length zone. The second filter portion 102B, among the light irradiated from the UV irradiation device 24, interrupts the light in the first wave length zone, though transmits the light in the second wave length zone.

The second filter member 103 is installed in correspondence to the second unit 26. The second filter portion 103 has a third filter portion 103A and a fourth filter portion 103B. The third filter portion 103A, among light irradiated from the UV irradiation device 24, interrupts the light in the second wave length zone, though transmits the light in the first wave length zone. The fourth filter portion 103B, among the light irradiated from the UV irradiation device 24, interrupts the light in the first wave length zone, though transmits the light in the second wave length zone.

Then, by referring to FIGS. 14 and 15, the switching operation of the first filter member 102 and second filter member 103 will be explained. FIG. 14 shows the status of the carriage 22 moving leftward with the first unit 25 of the UV irradiation device 24 positioned at the head. At this time, the first filter member 102 makes the first filter portion 102A face the first unit 25. The second filter member 103 makes the fourth filter portion 103B face the second unit 26. By doing this, from the first unit 25, among UV light, the light in the first wave length zone is irradiated and prior to printing, the sheet surface can be reformed. Further, from the second unit 26, the light in the second wave length zone is irradiated and the UV ink on the sheet is hardened.

When the carriage 22 reaches the left end of the carriage guide shaft 21, the carriage 22 moves rightward, that is, in the opposite direction with the second unit 26 of the UV irradiation device 24 positioned at the head. When the switching is performed, the first filter member 102 and second filter member 103, for example, strike against projections not drawn which are installed in the main body 12. By doing this, the first filter member 102 moves so as to permit the second filter portion 102B to face the first unit 25. Further, the second filter member 103 moves so as to permit the third filter portion 103A to face the second unit 26.

As shown in FIG. 15, when the carriage 22 moves rightward, from the second unit 26, among UV light, the light in the first wave length zone is irradiated and prior to printing, the sheet surface can be reformed. Further, from the first unit 25, the light in the second wave length zone is irradiated and the UV ink on the sheet S is hardened. When the carriage 22 reaches again the right end of the carriage guide shaft 21, the first filter member 102 and second filter member 103, for example, strike against projections not drawn which are installed in the main body 12 and return to the positions shown in FIG. 14. Even when the carriage 22 moves in any direction in this way, before and behind the ink jet head 23, light in an appropriate wave length zone is irradiated.

According to the ninth embodiment, the ink jet recording apparatus 101 further includes the second filter member 103 including the first filter member 102 having the first filter portion 102A installed in correspondence to the first unit 25 of the UV irradiation device 24 for interrupting, among light irradiated from the first unit 25, the second wave length zone and the second filter portion 102B for interrupting the first wave length zone and the second filter member 103 having the third filter portion 103A installed in correspondence to the second unit 26 of the UV irradiation device 24 for interrupting, among light irradiated from the second unit 26, the second wave length zone and the fourth filter portion 103B for interrupting the first wave length zone. When the carriage 22 moves with the first unit 25 positioned at the head, the first filter member 102 makes the first filter portion 102A face the first unit 25 and the second filter member 103 makes the fourth filter portion 103B face the second unit 26. When the carriage 22 moves with the second unit 26 positioned at the head, the first filter member 102 makes the second filter portion 102B face the first unit 25 and the second filter member 103 makes the third filter portion 103A face the second unit 26.

According to this constitution, even when the carriage 22 moves in any direction in the width direction, from the UV irradiation device 24 positioned at the head, prior to printing, the surface can be reformed by irradiating the first wave length zone. Further, after printing, from the UV irradiation device 24 positioned behind, UV ink can be fixed by irradiating the second wave length zone. Further, the UV wave length zone can be simply selected according to use and the constitution of the ink jet recording apparatus 101 can be simplified.

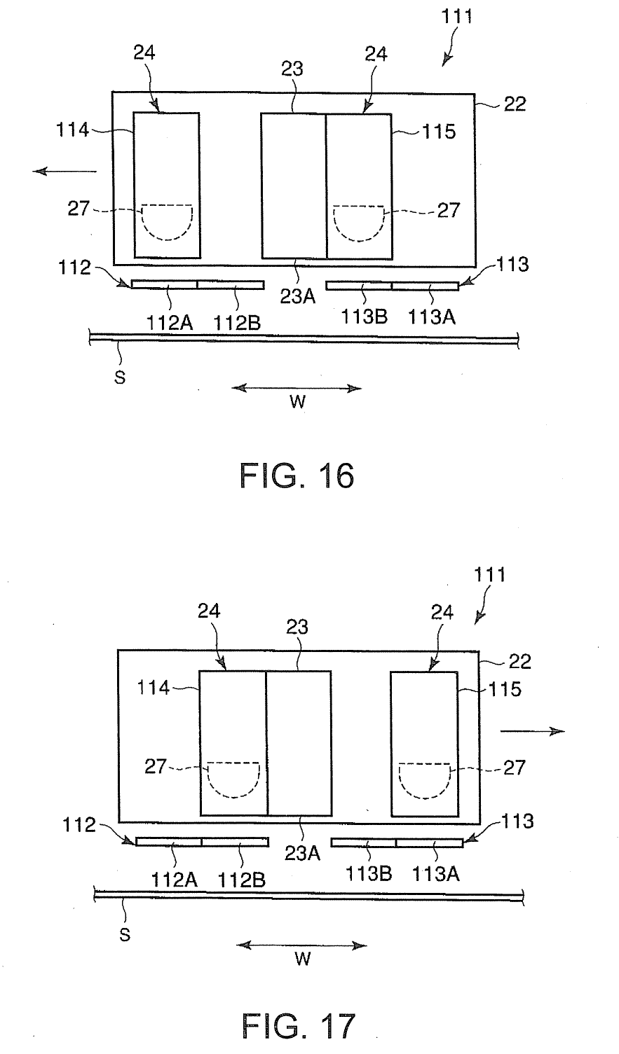

By referring to FIGS. 16 and 17, the tenth embodiment of an ink jet recording apparatus 111 will be explained. The ink jet recording apparatus 111 of the tenth embodiment is different in the respects that it has first and second filter members 112 and 113 and a first unit 114 and a second unit 115 of the UV irradiation device 24 are movable from the first embodiment, though the other portions are common. Therefore, the portions different from those of the first embodiment will be explained mainly and to the portions common to the first embodiment, the common numerals are assigned and the explanation thereof will be omitted.

The first filter member 112 is attached to the carriage 22 in correspondence to the first unit 114 of the UV irradiation device 24. The first filter member 112 has a first filter portion 112A and a second filter portion 112B. The first filter portion 112A, among light irradiated from the UV irradiation device 24, interrupts the light in the second wave length zone, though transmits the light in the first wave length zone. The second filter portion 112B, among the light irradiated from the UV irradiation device 24, interrupts the light in the first wave length zone, though transmits the light in the second wave length zone.

The second filter member 113 is attached to the carriage 22 in correspondence to the second unit 115 of the UV irradiation device 24. The second filter member 113 has a third filter portion 113A and a fourth filter portion 113B. The third filter portion 113A, among light irradiated from the UV irradiation device 24, interrupts the light in the second wave length zone, though transmits the light in the first wave length zone. The fourth filter portion 113B, among the light irradiated from the UV irradiation device 24, interrupts the light in the first wave length zone, though transmits the light in the second wave length zone.

Then, by referring to FIGS. 16 and 17, the switching operation of the first unit 114 and second unit 115 will be explained. FIG. 16 shows the status of the carriage 22 moving leftward with the first unit 114 of the UV irradiation device 24 positioned at the head. At this time, the first unit 114 faces the first filter portion 112A of the first filter member 112. The second unit 115 faces the fourth filter portion 113B of the second filter member 113. By doing this, from the first unit 114, among UV light, the light in the first wave length zone is irradiated and prior to printing, the sheet surface can be reformed. Further, from the second unit 115, the light in the second wave length zone is irradiated and the UV ink on the sheet is hardened.

When the carriage 22 reaches the left end of the carriage guide shaft 21, the carriage 22 moves rightward, that is, in the opposite direction with the second unit 115 of the UV irradiation device 24 positioned at the head. When the switching is performed, the first unit 114 and second unit 115, for example, strike against projections not drawn which are installed in the main body 12. By doing this, the first unit 114 moves to the position opposite to the second filter portion 112B. Further, the second unit 115 moves to the position opposite to the third filter portion 113A.

As shown in FIG. 17, when the carriage 22 moves rightward, from the second unit 115, among UV light, the light in the first wave length zone is irradiated and prior to printing, the sheet surface can be reformed. Further, from the first unit 114, the light in the second wave length zone is irradiated and the UV ink on the sheet S is hardened. When the carriage 22 reaches again the right end of the carriage guide shaft 21, the first filter member 112 and second filter member 113, for example, strike against projections not drawn which are installed in the main body 12 and return to the positions shown in FIG. 16. Even when the carriage 22 moves in any direction in this way, before and behind the ink jet head 23, light in an appropriate wave length zone is irradiated.

According to the tenth embodiment, the ink jet recording apparatus 111 further includes the second filter member 113 including the first filter member 112 having the first filter portion 112A installed in correspondence to the first unit 114 of the UV irradiation device 24 for interrupting, among light irradiated from the first unit 114, the second wave length zone and the second filter portion 112B for interrupting the first wave length zone and the second filter member 103 having the third filter portion 113A installed in correspondence to the second unit 115 of the UV irradiation device 24 for interrupting, among light irradiated from the second unit 26, the second wave length zone and the fourth filter portion 113B for interrupting the first wave length zone. When the carriage 22 moves with the first unit 114 positioned at the head, the first unit 114 moves to the position opposite to the first filter portion 112A and the second unit 115 moves to the position opposite to the fourth filter portion 113B. When the carriage 22 moves with the second unit 115 positioned at the head, the first unit 114 moves to the position opposite to the second filter portion 112B and the second unit 115 moves to the position opposite to the third filter portion 113A.

According to this constitution, even when the carriage 22 moves in any direction in the width direction, from the UV irradiation device 24 positioned at the head, prior to printing, the surface can be reformed by irradiating the first wave length zone. Further, after printing, from the UV irradiation device 24 positioned behind, UV ink can be fixed by irradiating the second wave length zone. Further, the UV wave length zone can be simply selected according to use and the constitution of the ink jet recording apparatus 111 can be simplified.

Although the invention is shown and described with respect to certain illustrated aspects, it will be appreciated that equivalent alterations and modifications will occur to others skilled in the art upon the reading and understanding of this specification and the annexed drawings. In particular regard to the various functions performed by the above described components, the terms used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention.

What is claimed is:

1. An ink jet recording apparatus comprising:
an ink jet head configured to discharge UV ink onto a printed article fed in a feeding direction;
an ultraviolet irradiation device having a single light source capable of irradiating light including a first wave length zone to reform a surface of the printed article and a second wave length zone for hardening the UV ink; and
a controller configured to control the light source so as to emit light in the first wave length zone and light in the second wave length zone.

2. The ink jet recording apparatus according to claim 1, wherein the light source includes a mercury lamp or a metal halide lamp.

3. The ink jet recording apparatus according to claim 1, wherein the first wave length zone is 400 to 315 nm and the second wave length zone is 280 to 10 nm.

4. The ink jet recording apparatus according to claim 1, wherein the UV irradiation device is a pair of UV irradiation devices including a first unit and a second unit and the ink jet head is arranged at a position between the first unit and the second unit.

5. The ink jet recording apparatus according to claim 4 further comprising a carriage configured to load the ink jet head and the UV irradiation device and moving back and forth in a width direction orthogonal to the feeding direction, wherein the ink jet head and the first unit and the second unit of the UV irradiation device are arranged in line with each other on the carriage in the width direction.

6. The ink jet recording apparatus according to claim 5, wherein the first unit and the second unit of the UV irradiation device respectively include corresponding portions corresponding to the ink jet head in the feeding direction and projecting portions off the ink jet head in the feeding direction and the projecting portions are arranged on the upstream side of the ink jet head in the feeding direction.

7. The ink jet recording apparatus according to claim 5 further comprising a filter member having a first filter portion installed in correspondence to the projecting portions for transmitting, among light irradiated from the first unit and the second unit of the UV irradiation device, the light in the first wave length zone and interrupting the light in the second wave length zone and a second filter portion installed in correspondence to the corresponding portions for transmitting, among the light irradiated from the first unit and the second unit of the UV irradiation device, the light in the second wave length zone and interrupting the light in the first wave length zone.

8. The ink jet recording apparatus according to claim 5, wherein the first unit and the second unit of the UV irradiation device respectively include corresponding portions corresponding to the ink jet head in the feeding direction and projecting portions off the ink jet head in the feeding direction and the projecting portions are arranged on the downstream side of the ink jet head in the feeding direction.

9. The ink jet recording apparatus according to claim 8 further comprising a filter member having a first filter portion installed in correspondence to the projecting portions for transmitting, among light irradiated from the first unit and the second unit of the UV irradiation device, the light in the first wave length zone and interrupting the light in the second wave length zone and a second filter portion installed in correspondence to the corresponding portions for transmitting, among the light irradiated from the first unit and the second unit of the UV irradiation device, the light in the second wave length zone and interrupting the light in the first wave length zone.

10. The ink jet recording apparatus according to claim 5, wherein the first unit and the second unit of the UV irradiation device respectively include corresponding portions corresponding to the ink jet head in the feeding direction and a first projecting portion and a second projecting portion off the ink jet head in the feeding direction, and the first projecting portion is arranged on the upstream side of the ink jet head in the feeding direction, and the second projecting portion is arranged on the downstream side of the ink jet head in the feeding direction.

11. The ink jet recording apparatus according to claim 10 further comprising a filter member having a first filter portion installed in correspondence to a part of the first projecting portion and the corresponding portion for transmitting, among light irradiated from the first unit and the second unit of the UV irradiation device, the light in the first wave length zone and interrupting the light in the second wave length zone and a second filter portion installed in correspondence to a part of the second projecting portion and the corresponding portion for transmitting, among the light irradiated from the first unit and the second unit of the UV irradiation device, the light in the second wave length zone and interrupting the light in the first wave length zone.

12. The ink jet recording apparatus according to claim 5 further comprising a first filter member having a first filter portion installed in correspondence to the first unit of the UV irradiation device for interrupting, among light irradiated from the first unit, the second wave length zone and a second filter portion for interrupting the first wave length zone and a second filter member having a third filter portion installed in correspondence to the second unit of the UV irradiation device for interrupting, among light irradiated from the second unit, the second wave length zone and a fourth filter portion for interrupting the first wave length zone, wherein when the carriage moves with the first unit positioned at the head, the first filter member makes the first filter portion face the first unit, and the second filter member makes the fourth filter portion face the second unit, and when the carriage moves with the second unit positioned at the head, the first filter member makes the second filter portion face the first unit, and the second filter member makes the third filter portion face the second unit.

13. The ink jet recording apparatus according to claim 5 further comprising a first filter member having a first filter portion installed in correspondence to the first unit of the UV irradiation device for interrupting, among light irradiated from the first unit, the second wave length zone and a second filter portion for interrupting the first wave length zone and a second filter member having a third filter portion installed in correspondence to the second unit of the UV irradiation device for interrupting, among light irradiated from the second unit, the second wave length zone and a fourth filter portion for interrupting the first wave length zone, wherein when the carriage moves with the first unit positioned at the head, the first unit moves to a position opposite to the first filter portion, and the second unit moves to a position opposite to the fourth filter portion, and when the carriage moves with the second unit positioned at the head, the first unit moves to a position opposite to the second filter portion, and the second unit moves to a position opposite to the third filter portion.

14. The ink jet recording apparatus according to claim 4, wherein the ink jet head and the first unit and the second unit of the UV irradiation device, in a width direction orthogonal to the feeding direction, are arranged extending over the full width of the printed article and are arranged in line with each other in the feeding direction.

15. An ink jet recording method comprising:
irradiating light in a first wave length zone from an ultraviolet irradiation device so as to improve wettability of a surface of a printed article fed in a feeding direction;
discharging UV ink to the printed article fed in the feeding direction and improved in the wettability; and
irradiating light in a second wave length zone from the ultraviolet irradiation device so as to harden the UV ink adhered to the printed article.

16. The ink jet recording method according to claim 15, wherein the ultraviolet irradiation device includes a single light source and the light source irradiates light including a first wave length zone to reform a surface of the printed article and a second wave length zone to harden the UV ink.

17. The ink jet recording method according to claim 16, wherein the UV irradiation device is a pair of UV irradiation devices including a first irradiation portion and a second irradiation portion and the UV ink is discharged by a UV ink discharge portion arranged at a position between the first irradiation portion and the second irradiation portion.

18. The ink jet recording method according to claim 17, wherein the ink discharge portion and the UV irradiation device can move back and forth in a width direction orthogonal to the feeding direction of the printed article and the ink discharge portion and the first irradiation portion and second irradiation portion of the UV irradiation device are arranged in line with each other in the width direction of the printed article.

19. An ink jet recording apparatus comprising:
ink discharge means for discharging UT ink onto a printed article fed in a feeding direction;
UV irradiation means having a single light source capable of irradiating light including a first wave length zone for reforming a surface of the printed article and a second wave length zone for hardening the UV ink; and
control means for controlling the light source so as to emit light in the first wave length zone and light in the second wave length zone.

20. The ink jet recording apparatus according to claim 19, wherein the light source includes a mercury lamp or a metal halide lamp.
